(19) United States
(12) Patent Application Publication
(10) Pub. No.: US 2017/0160386 A1
(43) Pub. Date: Jun. 8, 2017

(54) ULTRASONIC SENSOR DEVICE FOR A MOTOR VEHICLE, DRIVER ASSISTANCE SYSTEM, AND MOTOR VEHICLE

(71) Applicant: VALEO Schalter und Sensoren GmbH, Bietigheim-Bissingen (DE)

(72) Inventors: Paul-David Rostocki, Bietigheim-Bissingen (DE); Heinrich Gotzig, Bietigheim-Bissingen (DE)

(73) Assignee: VALEO Schalter und Sensoren GmbH, Bietigheim-Bissingen (DE)

(21) Appl. No.: 15/327,210

(22) PCT Filed: Jul. 8, 2015
(86) PCT No.: PCT/EP2015/065584

§ 371 Date: Jan. 18, 2017

(30) Foreign Application Priority Data
Jul. 18, 2014 (DE) 10 2014 110 179.0

(51) Int. Cl. G01S 7/521; G10K 9/122; G01S 15/93

(52) U.S. Cl. CPC G01S 7/521; G01S 15/931; G10K 9/122; G01S 2015/932

(57) ABSTRACT

The invention relates to an ultrasonic sensor device (1) for a motor vehicle, comprising an ultrasonic diaphragm (13), comprising a servomechanism (4), by means of which the ultrasonic diaphragm (13) can be moved in order to emit an ultrasonic signal, and comprising control electronics (12) for controlling the servomechanism (4), wherein the control electronics (12) are designed as an integrated circuit and are situated directly on the servomechanism (4).

The present invention relates to an ultrasonic sensor device for a motor vehicle, comprising an ultrasonic diaphragm, comprising a servomechanism, by means of which the ultrasonic diaphragm can be moved in order to emit an ultrasonic signal, and comprising control electronics for controlling the servomechanism. The invention also relates to a driver assistance system comprising such an ultrasonic sensor device. Finally, the present invention relates to a motor vehicle comprising such a driver assistance system.

Ultrasonic sensors and ultrasonic sensor devices are known from the serial production of motor vehicles. These sensors and devices are used for detecting an object in the surroundings of the motor vehicle and, in particular, for determining a distance to the object. For this purpose, an ultrasonic signal is generated by means of the ultrasonic sensor device and is reflected by an object. On the basis of the transit time of the reflected ultrasonic signal, the distance to the object can be determined by means of the ultrasonic sensor device.

The ultrasonic sensors used nowadays in motor vehicles comprise an ultrasonic diaphragm which can be, for example, part of a pot-shaped structure. This diaphragm is excited to oscillate in the ultrasonic range by means of a servomechanism which is usually designed as a piezoelectric actuator. Suitable control electronics, which can comprise an integrated circuit, a transformer, and other components, are usually used for controlling the servomechanism. The servomechanism or the actuator and the control electronics are usually situated in a housing. In addition, a shroud for electromagnetic shielding can be provided.

In this context, DE 10 2008 027 970 B4 describes an ultrasonic sensor which comprises a diaphragm and a piezoelectric element situated close to the diaphragm. The piezoelectric element is contacted to electronics which control the piezoelectric element. A damping layer is provided between the electronics and the piezoelectric element.

The problem addressed by the present invention is that of providing a solution for designing an ultrasonic sensor device for a motor vehicle to take up less installation space and to be more reliable.

This problem is solved, according to the invention, by an ultrasonic sensor device, by a driver assistance system, and by a motor vehicle having the features according to the respective independent claims. Advantageous embodiments of the invention are the subject matter of the dependent claims, the description, and the figures.

The ultrasonic sensor device according to the invention for a motor vehicle comprises an ultrasonic diaphragm, a servomechanism, by means of which the ultrasonic diaphragm can be moved in order to emit an ultrasonic signal, and control electronics for controlling the servomechanism, wherein the control electronics are designed as an integrated circuit and are situated directly on the servomechanism.

The present invention is based on the finding that the installation space of an ultrasonic sensor device for a motor vehicle can be reduced by designing the control electronics as an integrated circuit and situating these directly on the servomechanism. In particular, the control electronics are not situated on an additional circuit board. The control electronics can be formed on a substrate, in particular a semiconductor substrate. The control electronics can be designed as a so-called application-specific integrated circuit (ASIC). The control electronics can be situated, for example, in a separate housing. In this case, it can also be provided that the control electronics comprise suitable electrical contact elements for the electrical contacting of the control electronics. Thus a particularly installation-space-saving ultrasonic sensor device for a motor vehicle can be provided.

In one embodiment, at least sections of the servomechanism and the control electronics are integrally bonded to each other. For example, the servomechanism and the control electronics can be connected to each other by means of an adhesive bonding method. In particular, situated between the servomechanism and the control electronics is a damping layer which is used for transmitting mechanical vibrations, which occur during operation of the servomechanism, to the control electronics. In this way, the ultrasonic sensor device can be designed to be particularly installation-space-saving and inexpensive.

The control electronics preferably comprise electrical contact elements which are connected by means of soldering to corresponding connection elements of the servomechanism. The control electronics can comprise, for example, corresponding pins or legs which can be soldered onto corresponding contact pads of the servomechanism. Thus an electrical connection as well as a mechanical connection can be provided between the control electronics and the servomechanism. Thus cables, which can function as antennas, for example, can be dispensed with. In addition, the ultrasonic sensor device can be designed to be more robust, since a cable break, for example, cannot occur.

In yet another embodiment, the control electronics comprise electrical contact elements which are connected by means of a bonding method to corresponding connection elements of the servomechanism. The servomechanism and the control electronics can be electrically connected to each other, for example, by means of a wire-bonding method. Alternatively, the servomechanism and the control electronics can be electrically connected to each other by means of chip bonding or die bonding. In particular, in this case, the control electronics and the servomechanism are also mechanically connected to each other. This can be made possible, for example, by means of an adhesive bond. Thus a reliable electrical connection can be established between the control electronics and the servomechanism.

In one embodiment, the servomechanism comprises a piezoelectric transducer. The piezoelectric transducer can be situated directly on the ultrasonic diaphragm. The control electronics can be situated on the piezoelectric transducer on the side opposite the ultrasonic diaphragm. Thus the control electronics can be situated directly on the piezoelectric transducer or on the servomechanism. Thus a control board can be dispensed with. In addition, cables used for establishing the electrical connection between the circuit board and the servomechanism can be dispensed with.

In yet another embodiment, the servomechanism is designed as a micromechanical component. The servomechanism can therefore be produced using a microtechnical production method. For example, the servomechanism can be produced from a substrate, in particular a semiconductor material. In this case, the servomechanism can comprise a suitable moving member which is mechanically coupled to the ultrasonic diaphragm. Such a moving member can be moved, for example, piezoelectrically or electrostatically. Alternatively, the servomechanism can be designed as an electro-thermal-mechanical transducer or as an electro-magneto-mechanical transducer. Micromechanical components can be produced in large quantities and, therefore, are inexpensive.

Preferably, the servomechanism and the control electronics are formed on a shared substrate. The substrate can be, for example, a semiconductor material, in particular silicon. Both the control electronics and the servomechanism can be produced on the substrate by means of microelectronic and microtechnical production methods. Thus a particularly space-saving arrangement can be achieved and, furthermore, no additional electrical connections are required between the servomechanism and the control electronics, which are formed by wires, for example. Thus the influence of electromagnetic interferences can be reduced.

In addition, it is advantageous when the servomechanism is designed for detecting a movement of the ultrasonic diaphragm. Thus the ultrasonic wave emitted by the ultrasonic diaphragm, which was reflected by an object, can be detected again after a final oscillation time of the ultrasonic diaphragm. By means of the reflected ultrasonic wave, the ultrasonic diaphragm is excited to mechanically vibrate. This can be detected by means of the servomechanism. If the servomechanism comprises a piezoelectric element, the mechanical vibration of the ultrasonic diaphragm can be directly converted into an electrical signal. In addition, it can be provided that the servomechanism additionally comprises a measuring unit for detecting the vibration of the ultrasonic diaphragm. In this way, the ultrasonic wave reflected by the object can be reliably detected.

In yet another embodiment, the ultrasonic sensor device comprises a housing, in which the servomechanism is situated, wherein an area of the housing forms the ultrasonic diaphragm. In this case, it is also preferably provided that the control electronics are situated in the housing. The housing can be designed to be pot-shaped, for example, and can be produced from aluminium. In this case, an area of the aluminium pot can form the ultrasonic diaphragm. Thus an additional housing can be dispensed with, for example. If the housing is formed by an aluminium pot, said pot is advantageously used for shielding against electromagnetic interferences.

In yet another embodiment, the ultrasonic sensor device comprises an electrical connection device which is electrically connected to the servomechanism. This connection device can be designed, for example, as a socket which is mechanically connected to the housing of the ultrasonic sensor device. The connection device can also be provided for providing a connection to a data line of the ultrasonic sensor device.

The driver assistance system according to the invention comprises an ultrasonic sensor device according to the invention. The driver assistance system can be, for example, a distance warning device or can assist the driver upon entering or exiting a parking space.

The motor vehicle according to the invention comprises the driver assistance system according to the invention. The motor vehicle is designed as a passenger car, in particular.

The preferred embodiments, which are presented with reference to the ultrasonic sensor device according to the invention, and their advantages apply similarly for the driver assistance system according to the invention and for the motor vehicle according to the invention.

Further features of the invention will become apparent from the claims, the figures, and the description of the figures. All the features and combinations of features mentioned above in the description, and the features and combinations of features mentioned in the description of the figures that follows and/or shown only in the figures can be used not only in the particular combination indicated, but also in other combinations or alone.

The invention is explained in greater detail on the basis of a preferred exemplary embodiment and with reference to the attached drawings.

In the drawings:

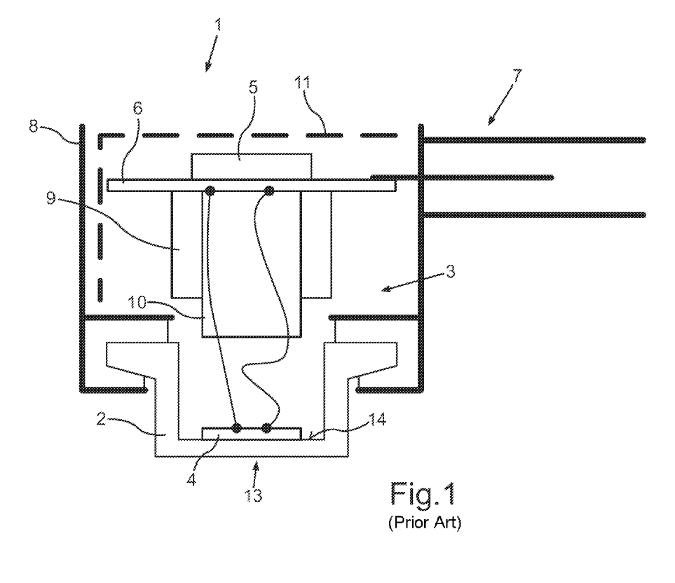

FIG. 1 shows a schematic representation of an ultrasonic sensor device according to the prior art; and

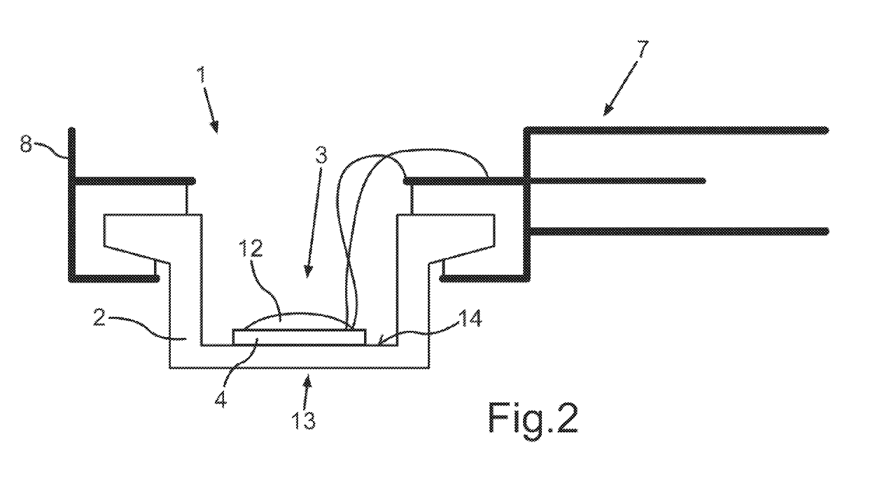

FIG. 2 shows a schematic representation of an ultrasonic sensor device according to one embodiment of the present invention.

FIG. 1 shows a cut side view of an ultrasonic sensor device 1 according to the prior art. The ultrasonic sensor device 1 is intended for use in a motor vehicle. For example, the ultrasonic sensor device 1 can be part of a driver assistance system which assists the driver during parking. The ultrasonic sensor device 1 comprises an ultrasonic diaphragm 13. In the present exemplary embodiment, the ultrasonic diaphragm 13 is part of an aluminium pot 2. The ultrasonic diaphragm 13 is therefore designed in the shape of a disc and is held by the side walls of the aluminium pot 2. The ultrasonic diaphragm 13 can be designed in such a way, for example, that said diaphragm has a resonance frequency between 40 kHz and 60 kHz.

In addition, the ultrasonic sensor device 1 comprises a control device 3. The control device 3 is used for controlling the ultrasonic diaphragm 13. The ultrasonic sensor device 1 also comprises a servomechanism 4. In the present example according to the prior art, the servomechanism 4 is designed as a piezoelectric element which is situated on a rear face 14 of the ultrasonic diaphragm 13. When an electrical voltage is applied to the control device 3, the piezoelectric element or the servomechanism 4 deforms. As a result, the ultrasonic diaphragm 13 is caused to mechanically vibrate. Thus an ultrasonic signal can be emitted.

The ultrasonic sensor device 1 also comprises control electronics 5 which are situated on a circuit board 6 or a printed circuit board. The circuit board 6 is connected to an electrical connection device 7 which, in the present exemplary embodiment, is designed as a socket. By means of the electrical connection device 7, an electrical connection can be established between the motor vehicle electrical system and the circuit board 6. In addition, a capacitor 10 which is designed, in particular, as an electrolytic capacitor, is situated on the circuit board 6. Electrical energy can be stored in the capacitor 10. In addition, a transformer 9 is situated on the circuit board 6, by means of which the electrical voltage drawn from the motor vehicle electrical system can be converted in order to control the servomechanism 4.

In the present exemplary embodiment, the ultrasonic sensor device also comprises a housing 8 which can be produced from plastic, for example. In the present case, the electrical connection device 7 is held on the housing 8. In addition, a shroud 11 is provided, which is used for preventing electromagnetic interferences from entering the housing 8.

FIG. 2 shows an ultrasonic sensor device 1 according to one embodiment of the invention. In this case, the control device 3 comprises the servomechanism 4 and control electronics 12 which are designed as a chip or an integrated circuit. In other words, the complete circuit for controlling the servomechanism 4 is designed as an integrated circuit or an application-specific integrated circuit. The integrated circuit or the control electronics 12 can be formed on a single substrate, for example a semiconductor substrate.

The servomechanism 4 can comprise, for example, a piezoelectric transducer. This piezoelectric transducer is situated directly on the rear face 14 of the ultrasonic diaphragm 13. The control electronics 12 are situated on the side of the servomechanism 4 opposite the ultrasonic diaphragm 13. The control electronics are designed as an integrated circuit, wherein the circuit comprises multiple electronic components which are produced on a substrate by means of a microelectronic production method. A semiconductor material, for example, can be used as the substrate material. The control electronics can comprise a suitable housing or a sealing compound, in which the chip or the integrated circuit is situated. The control electronics 12 can therefore be used without an additional circuit board 6. The control electronics 12 are a separate component.

Suitable contact pins or legs can be provided for the electrical contacting of the control electronics 12. These can be contacted, for example, by means of a soldering method. For example, suitable connection elements can be provided, which are used for the electrical contacting to the electrical connection device 7 or the socket. As shown in the present exemplary embodiment, the electrical connection element 7 can be electrically connected to the control electronics by means of suitable cables or bonding wires. In addition, the control electronics 12 can comprise suitable contact elements which can be soldered directly onto corresponding contact elements of the servomechanism 4. Thus an electrical connection as well as a mechanical connection can be provided between the servomechanism 4 and the control electronics 12. Instead of a soldered connection, a suitable bonded connection can also be provided. Additionally or alternatively, the servomechanism 4 and the control electronics 12 can be integrally bonded to each other. When the servomechanism 4 is moved during the transmit mode of the ultrasonic sensor device 1, amplitudes of a few micrometres, for example 5 micrometres, usually occur. The operation of the control electronics 12 is not influenced by mechanical vibrations having such an amplitude.

The servomechanism 4 can also be designed as a micromechanical component or as a MEMS component. The servomechanism 4 can comprise, for example, a moving member which is designed as a diaphragm or a cantilever beam. This moving member can be formed, for example, from a semiconductor element. Alternatively, the moving member can be formed from a ceramic, a plastic, or from other materials.

A piezoelectric element, for example, can be situated on this moving member. The piezoelectric element can be applied onto the moving member as a layer, for example. An electrical voltage can be applied to the piezoelectric element. As a result of the electrical voltage, the piezoelectric element can deform. In this case, the piezoelectric element can be designed in such a way that the longitudinal effect or the transverse effect is utilized. The moving member has a direct mechanical connection to the ultrasonic diaphragm 13, whereby said diaphragm can be moved.

In addition, it can also be provided that the servomechanism 4 is designed as an electrostatic transducer. In this case, two plates or electrodes can be provided, for example, of which at least one is designed to be movable and at which an electrical voltage can be applied. Due to the formation of an electrical field, one of the plates, for example, which is mechanically coupled to the ultrasonic diaphragm can be moved. Instead of a plate arrangement, a suitable comb structure or the like can be utilized, for example.

In addition, it can also be provided that the servomechanism 4 is designed as an electro-thermal-mechanical transducer. In this case, the servomechanism is designed for converting electrical energy, which is applied to the servomechanism, for example, in the form of electrical voltage, into thermal energy or heat. In addition, the servomechanism can be designed in such a way that the heating thereof results in a mechanical deformation of a moving member, which acts on the ultrasonic diaphragm 13. In this case, the servomechanism 4 can have, for example, a bimetal arrangement which comprises two different materials which have different coefficients of thermal expansion.

In addition, it can be provided that the servomechanism comprises a substance which undergoes a phase transition as a result of the heating. For example, a liquid can be evaporated as a result of the heating. Due to the resultant volume expansion, a moving member can be moved and thereby act on the ultrasonic diaphragm 13. In this case, it can also be provided that the servomechanism 4 comprises a shape memory alloy (SMA). Shape memory alloys of this type can assume a predetermined shape, for example, when heated.

In addition, the servomechanism 4 can be designed as an electro-magnetic-mechanical transducer. In this case, the force used for moving the ultrasonic diaphragm 13 can be provided as a result of the Lorentz force. For example, by means of a current-carrying conductor, a magnetic field can be provided, in which a moving member is located and which is thereby correspondingly moved. In addition, it is also conceivable that the reluctance principle is utilized. The servomechanism 4 can also comprise a correspondingly micromechanically produced coil which provides a magnetic field, by means of which a moving member can be moved. In addition, it is also conceivable that the servomechanism is designed as a micromechanical motor or drive.

In the present exemplary embodiment, the control electronics 12 are situated on the side of the servomechanism 4 opposite the ultrasonic diaphragm 13. It can also be provided that the servomechanism 4 is formed, together with the control electronics 12, on a shared substrate, in particular a semiconductor substrate. The servomechanism 4 can also be designed, in particular, for detecting a mechanical motion or vibration of the ultrasonic diaphragm 13. Thus the ultrasonic wave reflected by an object can be detected again. In this case, it can also be provided that the control electronics 12 are designed for detecting or processing an electrical signal which is provided by the servomechanism 4 as a result of the movement of the ultrasonic diaphragm 13.

Due to the ultrasonic sensor device 1, an installation-space-saving arrangement can be achieved as compared to the ultrasonic sensor device according to FIG. 1. In addition, the control electronics 12 are situated within the aluminium pot 2 which is used for the electromagnetic shielding of the control electronics 12. In this case, it is also conceivable that at least a portion of the aluminium pot 2 is used as housing for the ultrasonic sensor device 1. Thus the shroud 11 can be dispensed with, for example. Given that the servomechanism 4 is designed as a micromechanical component, less electrical power can be required for operating the servomechanism 4. Thus the transformer 9 and/or the capacitor 10, for example, can be dispensed with. In addition, a servomechanism 4 which is designed as a micromechanical component can be produced in large quantities and, therefore, inexpensively. In addition, a shorter final oscillation time of the servomechanism or of the combination of servomechanism 4 and ultrasonic diaphragm 13 can result, since the servomechanism 4 is actively controlled.

1. An ultrasonic sensor device for a motor vehicle, comprising:
an ultrasonic diaphragm comprising a servomechanism, by which the ultrasonic diaphragm is moved in order to emit an ultrasonic signal; and
control electronics for controlling the servomechanism, wherein the control electronics are configured as an integrated circuit and are situated directly on the servomechanism.

2. An ultrasonic sensor device according to claim 1, wherein at least sections of the servomechanism and the control electronics are integrally bonded to each other.

3. An ultrasonic sensor device according to claim 1, wherein the control electronics comprise electrical contact elements which are connected via soldering to corresponding connection elements of the servomechanism.

4. An ultrasonic sensor device according to claim 1, wherein the control electronics comprise electrical contact elements which are connected via a bonding method to corresponding connection elements of the servomechanism.

5. An ultrasonic sensor device according to claim 1, wherein the servomechanism comprises a piezoelectric transducer.

6. An ultrasonic sensor device according to claim 1, wherein the servomechanism (4) is designed as a micromechanical component.

7. An ultrasonic sensor device according to claim 1, wherein the servomechanism and the control electronics are formed on a shared substrate.

8. An ultrasonic sensor device according to claim 1, wherein the control electronics are for detecting a movement of the ultrasonic diaphragm.

9. An ultrasonic sensor device according to claim 1, further comprising a housing, in which the servomechanism is situated, wherein an area of the housing forms the ultrasonic diaphragm.

10. An ultrasonic sensor device according to claim 1, further comprising an electrical connection device which is electrically connected to the servomechanism.

11. A driver assistance system comprising an ultrasonic sensor device according to claim 1.

12. A motor vehicle comprising a driver assistance system according to claim 11.
